(19) United States
(12) Patent Application Publication
(10) Pub. No.: US 2013/0083317 A1
(43) Pub. Date: Apr. 4, 2013

(54) IMAGE ACQUISITION APPARATUS, IMAGE ACQUISITION METHOD, AND MICROSCOPE

(71) Applicants: Hirofumi Fujii, Toyono-gun (JP); Michio Yanagisawa, Utsunomiya-shi (JP)

(72) Inventors: Hirofumi Fujii, Toyono-gun (JP); Michio Yanagisawa, Utsunomiya-shi (JP)

(73) Assignee: CANON KABUSHIKI KAISHA, Tokyo (JP)

(21) Appl. No.: 13/610,561

(22) Filed: Sep. 11, 2012

(30) Foreign Application Priority Data
Sep. 29, 2011 (JP) 2011-214966

(51) Int. Cl. G01B 11/26

(52) U.S. Cl. 356/138

(57) ABSTRACT

An image acquisition apparatus includes an image-forming optical system configured to form an image of an observation area in a plane of a subject, an image sensor including a light receiving surface configured to capture an image of the observation area formed by the image-forming optical system, and a rotation unit configured to rotate at least one of the subject and the image sensor within a plane perpendicular to an optical axis of the image-forming optical system. By driving of the rotation unit, the image acquisition apparatus changes a relative position of the observation area and the light receiving surface within the plane perpendicular to the optical axis of the image-forming optical system, to capture an image of an area in the observation area not captured at a time of image capturing before driving of the rotation unit.

### BACKGROUND OF THE INVENTION

1. Field of the Invention

The present invention relates to an image acquisition apparatus, an image acquisition method, and a microscope that perform image capturing of a subject a plurality of times.

2. Description of the Related Art

In recent pathological diagnosis, a demand for a microscope (an image acquisition apparatus) capable of capturing an image of a subject (a prepared slide) including a specimen such as tissue in a human body and acquiring digital image data of the prepared slide has been increasing. Acquisition of a digital image of the prepared slide is advantageous, for example, in that time degradation of the specimen does not need to be considered or image data can be shared remotely with a pathologist. However, since a high-resolution image becomes necessary in the pathological diagnosis, a data amount of an acquired digital image increases and an image capturing time with the image acquisition apparatus becomes longer. Accordingly, there is a need for improving throughput of image data acquisition.

As a method for obtaining higher throughput of the image data acquisition, increasing a data amount that can be acquired through one image capturing using a large-view-angle image acquisition apparatus can be considered. However, even though a large viewing angle is simply adopted, no large image sensor that can support the large viewing angle is available. Then, a method for supporting the large viewing angle through a two-dimensional arrangement of a plurality of image sensors can be considered. However, the image sensors may not be arranged all over due to limitations on wiring or design. Further, in a general image sensor, a base circuit and a base surface including amounting portion is present around a light receiving surface that actually detects light. Thus, an area that is unusable for image capturing occurs even when image sensors are arranged all over. Accordingly, even when a subject image is captured using a plurality of image sensors, a blank area occurs in an acquired image.

Japanese Patent Application Laid-Open No. 2009-003016 discusses a microscope including a plurality of image sensors in which, when a larger subject than an area capable of being imaged at a time is observed, the subject is moved along two axes perpendicular to an optical axis to perform image capturing a plurality of times. By combining a plurality of acquired images, an image of the entire subject can be acquired with no blank areas occurring due to a base surface.

However, when the image capturing is performed a plurality of times while parallel shifting (translating) the subject in biaxial directions, moving the subject using the driving mechanism may cause the center of gravity of the apparatus to be moved and the inside of the apparatus to be deformed under its own weight. Further, when the parallel shifting is performed in the biaxial directions, it is difficult to perform stable positioning control within a range of moving the subject.

### SUMMARY OF THE INVENTION

An example of the present invention is directed to an image acquisition apparatus capable of, when a subject image is captured a plurality of times by the image acquisition apparatus, suppressing shifting of the center of gravity of the apparatus and deformation of the inside of the apparatus under its own weight, which are caused by driving of a driving mechanism, and capable of performing stable positioning of the driving mechanism.

According to an aspect of the present invention, an image acquisition apparatus includes an image-forming optical system configured to form an image of an observation area in a plane of a subject, an image sensor including a light receiving surface configured to capture the image of the observation area formed by the image-forming optical system, and a rotation unit configured to rotate at least one of the subject and the image sensor within a plane perpendicular to an optical axis of the image-forming optical system. By driving of the rotation unit, the image acquisition apparatus changes a relative position of the observation area and the light receiving surface within the plane perpendicular to the optical axis of the image-forming optical system, to capture an image of an area in the observation area not captured at a time of image capturing before driving of the rotation unit.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a schematic diagram illustrating an image acquisition apparatus according to an exemplary embodiment of the present invention.

FIGS. 2A and 2B are schematic diagrams illustrating an imaging unit.

FIGS. 3A, 3B, 3C and 3D are conceptual diagrams illustrating an image acquisition method according to the first exemplary embodiment.

FIG. 4 is a diagram illustrating an arrangement of light receiving surfaces in the imaging unit according to the first exemplary embodiment.

FIG. 5 is a diagram illustrating an arrangement of light receiving surfaces in an imaging unit according to a second exemplary embodiment, a third exemplary embodiment and a fourth exemplary embodiment.

FIGS. 6A, 6B and 6C are conceptual diagrams illustrating an image acquisition method according to the second exemplary embodiment.

FIG. 7 is a conceptual diagram illustrating an image acquisition method according to the third exemplary embodiment.

FIGS. 8A, 8B, 8C and 8D are conceptual diagrams illustrating a positional relationship between a light receiving surface and a rotation center according to the fourth exemplary embodiment.

FIGS. 9A, 9B, 9C, 9D and 9E are conceptual diagrams illustrating an image capturing completion area in an image acquisition method according to the fourth exemplary embodiment.

FIG. 10 is a schematic diagram illustrating a rotation unit for performing positioning every 90°.

FIG. 11 is a schematic diagram illustrating a mechanism for parallel shifting a subject.

FIG. 12 is a schematic diagram illustrating a mechanism for changing a rotation center at the time of rotation of the light receiving surface.

FIGS. 13A and 13B are conceptual diagrams illustrating coordinate systems of light receiving surfaces and image data corresponding to the light receiving surfaces.

FIG. 14 is a flowchart illustrating a sequence when image acquisition is performed according to a fifth exemplary embodiment.

### DESCRIPTION OF THE EMBODIMENTS

Various exemplary embodiments, features, and aspects of the invention will be described in detail below with reference to the drawings.

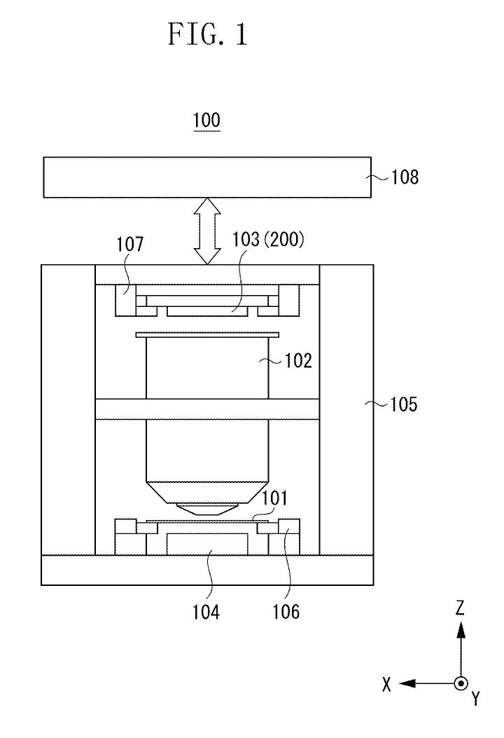

FIG. 1 is a schematic diagram illustrating an image acquisition apparatus 100 as a microscope according to an exemplary embodiment of the present invention. In the image acquisition apparatus 100, a light beam from a subject 101 illuminated by an illumination unit 104 is incident on an image-forming optical system 102, and an expanded image of the subject 101 is formed on an imaging unit 103 by the image-forming optical system 102. Note that, each member is supported by an entire support structure 105. Further, the image acquisition apparatus 100 includes a rotation unit capable of rotating at least one of the subject 101 and the imaging unit 103 around an optical axis. The rotation unit in the present exemplary embodiment includes a subject rotation unit 106 and an imaging-unit rotation unit 107. Using the rotation units, the subject 101 and the imaging unit 103 can be freely rotated within a plane perpendicular to the optical axis. Accordingly, at least one of the subject 101 and the imaging unit 103 is rotated to change a relative position, so that image capturing can be performed a plurality of times while changing an observation area within the same plane of the subject 101. Note that, the observation area refers to an area desired to be imaged (region of interest, ROI) in the subject.

Thus, when the image capturing is performed a plurality of times while changing the observation area of the subject 101, use of the mechanism for rotating the subject 101 or the imaging unit 103 can suppress deformation of the inside of the apparatus under its own weight, which is caused by shifting of the center of gravity, as compared to a case in which the subject is parallel shifted (translated). Here, since the rotation of the subject 101 and the rotation of the imaging unit 103 can be considered equivalent, the present exemplary embodiment may be established even when the rotations are replaced with each other.

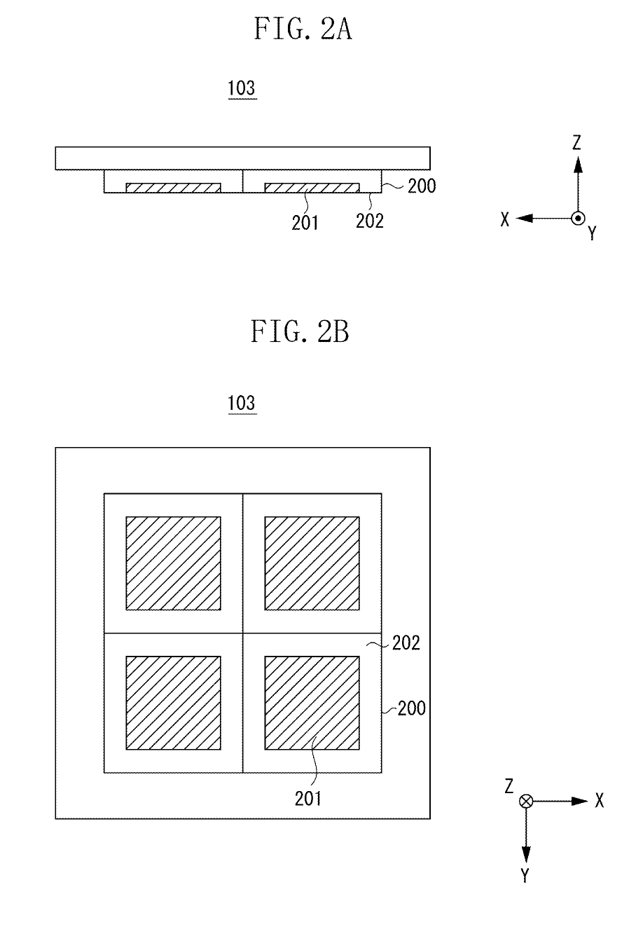

Next, the imaging unit 103 of FIG. 1 will be described in detail with reference to FIGS. 2A and 2B. A image sensor is divided into a light receiving surface configured to receive a light from a subject using, for example, a photodiode, and a base surface including a mounting portion configured to output a signal from the light receiving surface to the outside. Note that, the light receiving surface refers to an active pixel area of the image sensor. Accordingly, as illustrated in FIGS. 2A and 2B, the base surface 202 is present between the light receiving surfaces 201 even when the image sensors 200 are arranged all over with no gaps. For this reason, the light receiving surfaces 201 cannot be arranged all over with no gaps and it may be difficult to acquire image data with no gaps by one image capturing.

In the image acquisition apparatus according to the present exemplary embodiment, at least one of a subject (not illustrated) and the light receiving surface 201 is rotated to perform image capturing while changing a relative position of the light receiving surface 201 and the subject. Thus, in order to eliminate a blank due to the base surface 202, the image capturing is performed a plurality of times and the acquired image data are combined by the image processing unit 108. As a result, image data of the entire subject can be acquired with no gaps. Note that, since it is difficult to rotate only the light receiving surface 201, the imaging unit 103 including a plurality of image sensors 200 is rotated in the present exemplary embodiment. Here, while the imaging unit 103 including four image sensors 200 arranged therein is illustrated in FIGS. 2A and 2B, the number of image sensors is not limited thereto and may be appropriately determined according to a size or a form of the light receiving surfaces 201. Further, the present exemplary embodiment may be effective even when only one image sensor 200 is arranged in the imaging unit 103.

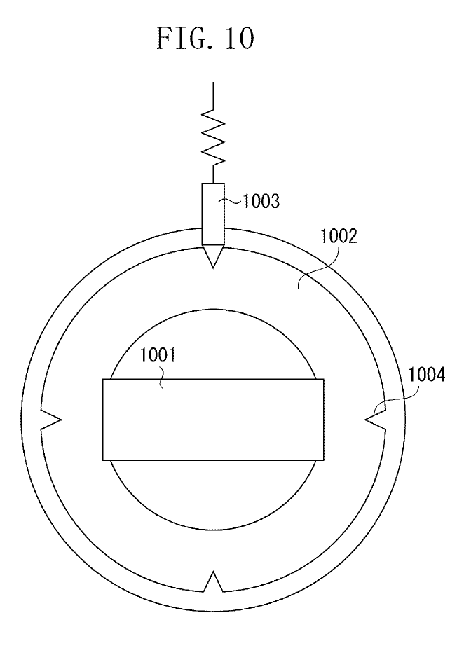

A mechanism capable of positioning the subject or the imaging unit at any rotation angle, using a motor and a gear or a pulley, may be used as a rotation unit for the image capturing as described above. In particular, a mechanism for rotating the subject or the imaging unit and positioning the subject or the imaging unit every 90°, which is used in each exemplary embodiment described below, will be described. For example, there may be considered a method for driving the subject or the imaging unit by providing a Geneva mechanism stopping every 90° and by mechanically contacting, using a gear or a pulley, a subject or an imaging unit desired to be rotated. Further, as illustrated in FIG. 10, a notch 1004 may be provided every 90° in a rotating base 1002 that holds a subject 1001 rotatably, and a wedge 1003 may be inserted into the notch 1004 so that the subject or the imaging unit can be positioned. Note that, when a rotation operation is performed, the wedge 1003 may be separated from the rotating base 1002 using a retracting mechanism, which is not illustrated.

As described above, use of the rotation unit to capture the subject image a plurality of times can suppress shifting of the center of gravity of the inside of the apparatus and deformation under its own weight, and can perform stable positioning when the subject or the imaging unit is driven.

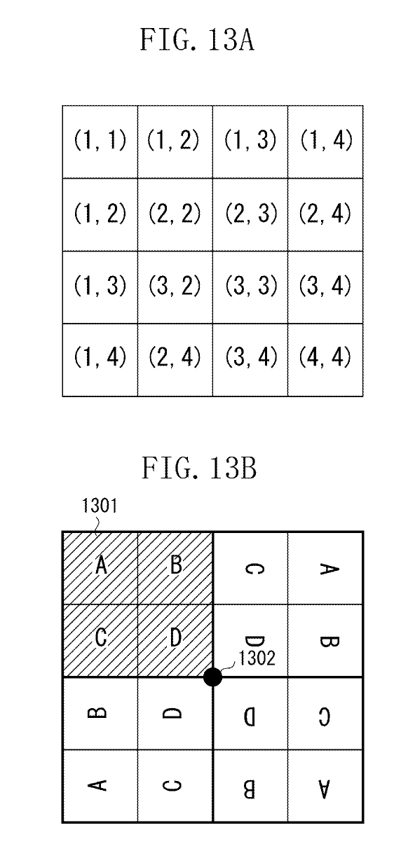

Next, coordinate conversion of a plurality of image data that can be acquired by rotating the subject or the imaging unit and performing image capturing a plurality of times will be described. FIG. 13A illustrates coordinates of an observation area of a subject (an area desired to be imaged). Further, FIG. 13B illustrates an image of an area in FIG. 13A captured by the respective light receiving surfaces when a light receiving surface 1301 (areas A to D) capable of capturing a 2×2 area in the observation area is rotated around a rotation center 1302. It can be seen that when the light receiving surface 1301 is rotated by 90° to perform image capturing, the image data captured at each of areas A to D is also rotated by 90°, as illustrated in FIG. 13B. Accordingly, when a plurality of image data captured at areas A to D is combined, a coordinate conversion process of each piece of image data in an image processing unit becomes required. Specifically, when a rotation angle of the image data is set to θ, the coordinate conversion according to the rotation angle may be performed by applying a rotation matrix R (θ) shown in the following equation (1) to a coordinate system of each piece of acquired image data.

$$R ( θ ) = ( \begin{matrix}cos θ & - sin θ \\ sin θ & cos θ\end{matrix} ) \qquad ( 1 )$$

Here, in FIG. 13B, the rotation angle θ at an initial state indicated by hatching is set to 0° and each of 90°, 180°, and 270° is applied to the rotation matrix R (θ) to thereby obtain a rotation matrix according to the rotation angle of each piece of image data. Note that, the rotation matrix R (θ) is represented by 0, 1 and −1 at any rotation angle θ, which shows that the process can be performed only with replacement of a coordinate system or replacement of a sign. Through the process as described above, the image data acquired by capturing the subject image a plurality of times can be combined and the image of the entire observation area with no gaps can be generated.

With the image acquisition apparatus according to the present exemplary embodiment, even when an area of a large subject is observed with high resolution (e.g., when a 10 mm square area is observed with resolution of 0.25 μm in pathological diagnosis), the image data can be acquired with higher throughput.

Hereinafter, the image acquisition apparatus in each exemplary embodiment of the present invention will be described in detail.

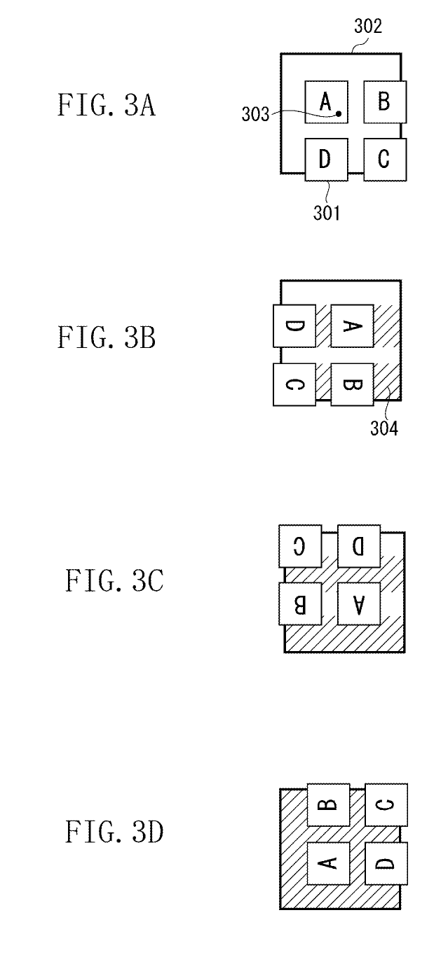

FIGS. 3A, 3B, 3C and 3D illustrate conceptual diagrams indicating that an imaging unit (not illustrated) according to a first exemplary embodiment of the present invention is rotated with respect to a subject to perform image capturing in a case in which the imaging unit includes four image sensors. Here, an observation area of the subject is indicated by 302, a light receiving surface of the image sensor is indicated by 301, and a rotation center when the imaging unit is rotated is indicated by 303. Further, letters A to D are assigned to the light receiving surfaces 301, respectively, so that it is easy to recognize that the light receiving surfaces 301 is rotated when the imaging unit is rotated. Note that, the observation area in the present exemplary embodiment refers to an area desired to be imaged in the subject and is not limited to the entire area of the subject.

In the present exemplary embodiment, a rotation angle of the light receiving surface 301 in FIG. 3A indicating an initial state is set to 0°, and an image of the observation area 302 is captured while rotating the imaging unit by 90° clockwise from the initial state. Specifically, the image capturing is performed in the state in which the rotation angle is 0° (as in FIG. 3A) and the image capturing is performed in positions at which the rotation angle becomes 90° (as in FIG. 3B), 180° (as in FIG. 3C), and 270° (as in FIG. 3D). Note that, portions indicated by oblique lines in FIGS. 3B to 3D are image capturing completion areas 304 for which the image capturing has been completed. It can be seen that an image of the entire observation area 302 can be captured by rotating the light receiving surface 301 by 90° clockwise to perform the image capturing a total of four times. Note that, while in the present exemplary embodiment, the light receiving surface 301 is rotated by 90° clockwise to perform the image capturing, the light receiving surface 301 may be rotated so that the image of the entire observation area 302 can be captured irrespective of the rotation angle and the rotation direction. Further, the subject may be rotated, as with the imaging unit, to perform image capturing. For example, a relative position of the observation area 302 and the light receiving surface 301 may be changed by 90°, as illustrated in FIGS. 3A, 3B, 3C and 3D, by simultaneously rotating the imaging unit and the subject around the same rotation center.

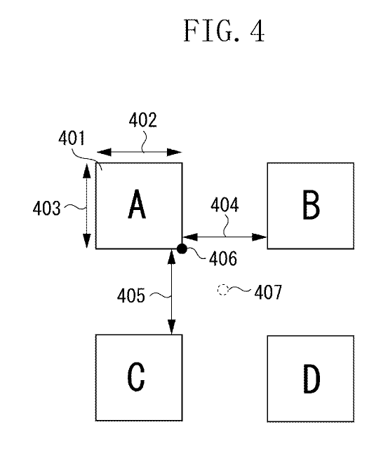

Next, an arrangement of the image sensors for capturing the entire observation area as illustrated in FIGS. 3A, 3B, 3C and 3D will be described. FIG. 4 illustrates a state in which the four image sensors each having the light receiving surface 401 are arranged in a lattice shape on an image surface. When the four image sensors are used, it is desirable that the image sensors be arranged so that a horizontal length 402 and a vertical length 403 of the light receiving surface 401, and a horizontal distance 404 and a vertical distance 405 to an adjacent light receiving surface are equal. In a mathematical representation, when coordinates on a Cartesian coordinate system, which is an orthogonal coordinate system, are (x, y), an area represented by 2 NL≦x≦2 NL+L and 2 ML≦y≦2 ML+L (N and M. are integers and L is a length of one side of an ideal image capturing square) is a light receiving surface. Note that, L denotes a length of one side when one light receiving surface is an ideal square, and is represented as the following equation (2).

$$L = \sqrt{\frac{area of observation area}{4 \times number of image sensors}} \qquad ( 2 )$$

Further, it is desirable that the rotation center 406 be set to a position of any one of opposite vertexes in each light receiving surface 401. This is because, for example, when the rotation center is set to a position 407, the respective light receiving surfaces 401 are rotationally symmetrical to the position 407, and accordingly only an image of the same area can be captured even when the light receiving surface is rotated by 90°. Accordingly, the rotation center 406 is set as illustrated in FIG. 4 so that the respective light receiving surfaces 401 are arranged not to be rotationally symmetrical to the rotation center 406. This enables an image of the observation area to be captured with no gaps by the rotation image-capturing operation as described with reference to FIGS. 3A, 3B, 3C and 3D. Provided that, FIG. 4 is a diagram illustrating an ideal state in which the light receiving surfaces 401 is assumed to be able to be accurately arranged and the light receiving surfaces 401 is assumed to be able to be accurately rotated. However, in fact, even when image capturing is performed four times, a blank area that cannot be imaged may occur, for example, due to misalignment of the image sensors caused by an error in rotating the imaging unit or an error in mounting the imaging unit. As illustrated in FIGS. 3A, 3B, 3C and 3D, it is desirable to narrow a distance between the light receiving surfaces or to set the rotation center 303 to be included on a boundary or inside of the light receiving surface 301 by using the light receiving surface 301 larger than the light receiving surface 401 in the ideal state (as in FIG. 4). This can cause an overlapping portion in the image capturing completion area. As a result, the image data can be acquired with no gaps by image-processing the overlapping portion caused after an image of the entire observation area is captured. Note that, when the subject is rotated, an area optically conjugate to the light receiving surface on a plane including the subject is arranged to include the rotation center. Thus, the image capturing can be performed, as in the case in which the imaging unit is rotated.

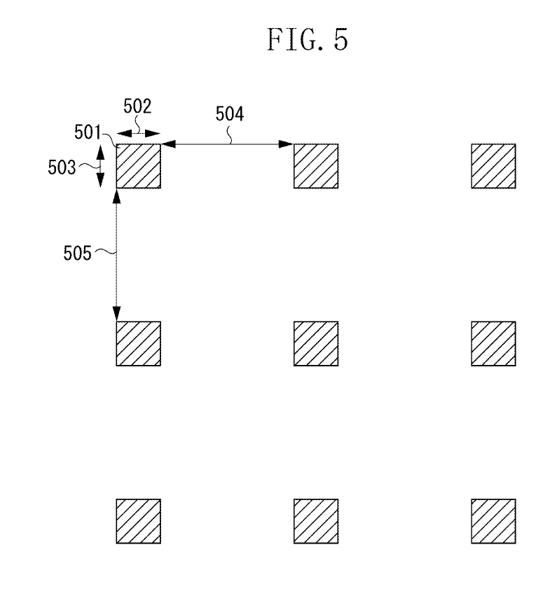

In a second exemplary embodiment of the present invention, an arrangement of the image sensors when the light receiving surface is smaller than the base surface and the distance between the image sensors cannot be shortened will be described. Specifically, a distance between the light receiving surfaces is 2 to 4 times the length of one short side of the light receiving surface, and a blank area occurs even when image capturing is performed four times, as illustrated in FIGS. 3A, 3B, 3C and 3D. In this case, it is desirable that distances 504 and 505 between light receiving surfaces 501 be 3 times the length 502 of one side of the light receiving surface, as illustrated in FIG. 5. Note that, here, a light receiving surface 501 is a square, and the horizontal length 502 is equal to a vertical length 503. In a mathematical representation, when coordinates on an orthogonal coordinate system are (x, y), the light receiving surface 501 may be arranged in an area represented as 4 NL₁₆≦x≦4 NL₁₆+L₁₆ and 4 ML₁₆≦y≦4 ML₁₆+L₁₆ (N and M. are integers and L₁₆ is a length of one side of an ideal image capturing square). Here, L₁₆ denotes a length of one side when one light receiving surface is assumed to be an ideal square, and is represented as the following equation (3). Note that, since FIG. 5 is a diagram illustrating an ideal state, a size or an arrangement of a real light receiving surface may be designed to include each of the light receiving surfaces 501 and is not limited to that illustrated in FIG. 5.

$${L}_{16} = \sqrt{\frac{area of observation area}{16 \times number of image sensors}} \qquad ( 3 )$$

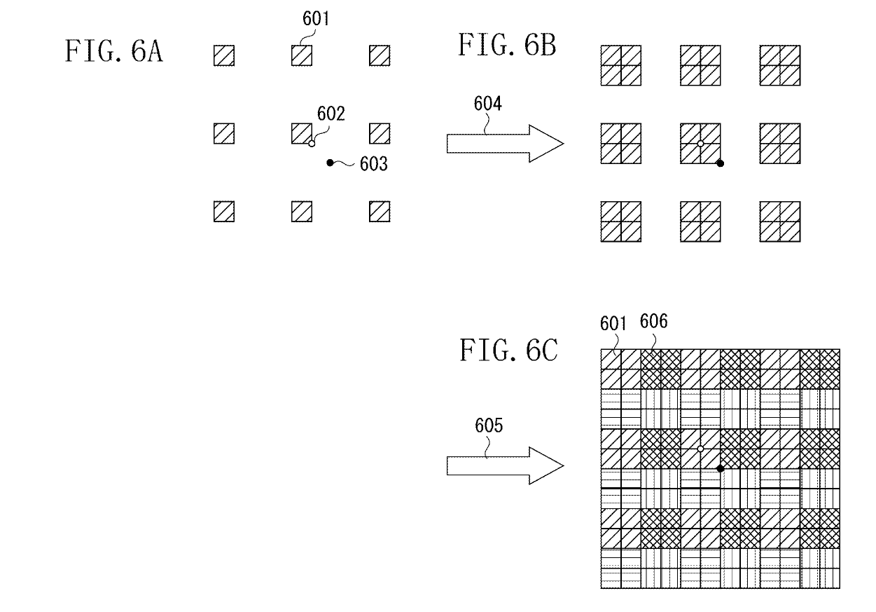

Next, an image capturing procedure in rotating both of the imaging unit and the subject will be described with reference to FIGS. 6A, 6B and 6C. Note that, an arrangement of light receiving surfaces 601 in FIGS. 6A, 6B and 6C is the same as the arrangement of the light receiving surfaces 501 in FIG. 5. 602 indicates a rotation center when the imaging unit is rotated, 603 indicates a result of photographing, on the imaging unit, a rotation center when the subject is rotated. Both are set not to be matched within a plane. As in the first exemplary embodiment, an operation (604) of rotating the imaging unit around the rotation center 602 by 90° from an initial state of FIG. 6A and performing image capturing four times, and accordingly, portions indicated by oblique lines in FIG. 6B become image capturing completion areas. Further, the subject is rotated by 90° around the rotation center 603, the imaging unit is rotated by 90° around the rotation center 602 and image capturing is performed four times, similar to the above process. Through the image capturing, portions indicated by a diagonal lattice in FIG. 6C become image capturing completion areas 606. Thus, an operation (605) of rotating the imaging unit around the rotation center 602 while rotating the subject by 90° around the rotation center 602 to perform the image capturing.

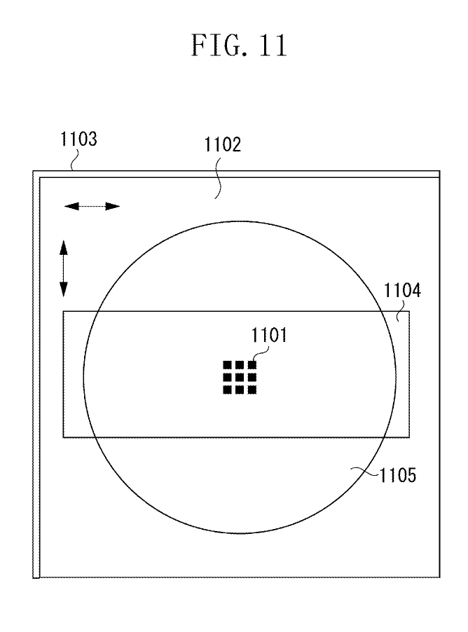

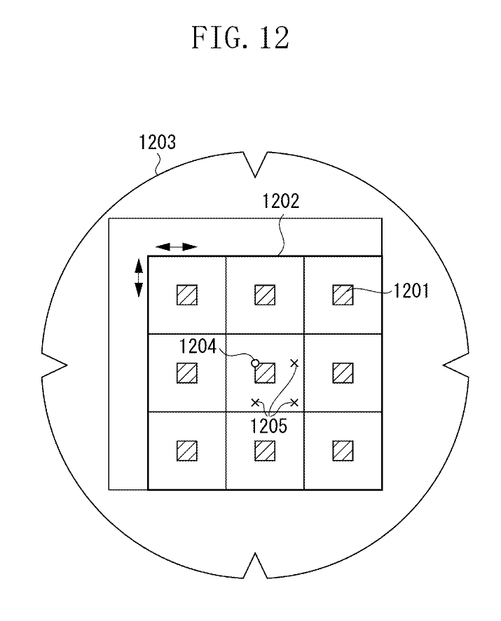

As a total of 16 image capturing operations are performed as described above, the entire area illustrated in FIG. 6C becomes the image capturing completion area. Accordingly, even when the light receiving surface is smaller than the observation area and a blank area that cannot be imaged occurs only with the rotation of the imaging unit, the rotation of the subject around a different rotation center enables the image data to be acquired with no gaps. Note that, the rotation centers in rotating the imaging unit and the subject may be replaced, and the subject may be rotated to perform image capturing four times in each position after which the imaging unit is rotated. Further, the rotation angles and the rotation directions of the imaging unit and the subject are not limited to those in the present exemplary embodiment, similar to the first exemplary embodiment. Note that, when the imaging unit and the subject are rotated around the different rotation centers, the mechanism as illustrated in FIG. 11 or 12 may be used (details will be described below).

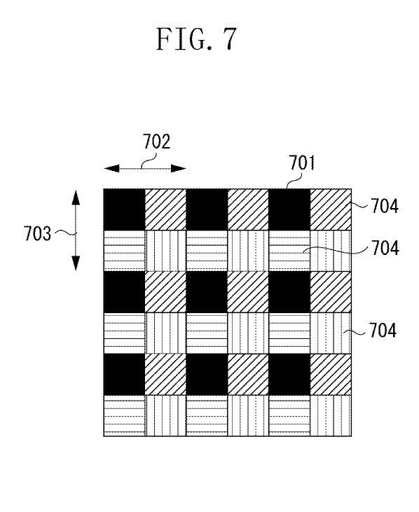

FIG. 7 is a diagram illustrating a case in which an image of the observation area is captured with no gaps by a combination of rotation of the imaging unit and parallel shifting (translating) of the subject. In the imaging unit of a third exemplary embodiment of the present invention, the light receiving surface is also arranged as illustrated in FIG. 5. First, the imaging unit is rotated from the state of FIG. 6A and image capturing is performed to obtain the image capturing completion area as illustrated in FIG. 6B, similar to the second exemplary embodiment. This image capturing completion area is illustrated as an initial image capturing completion area 701 in FIG. 7. Also, in the present exemplary embodiment, after the image capturing of the initial image capturing completion area 701 is completed, the subject is moved in an X axis direction 702 and a Y axis direction 703, and then the imaging unit is rotated to perform the image capturing four times, similar to the above-described process. Further, a similar image capturing operation is performed while moving the subject to a different position, such that an image capturing completion area 704 after moving the subject can be obtained. Thus, as the imaging unit is rotated while moving the subject in the X and Y axis directions to perform the image capturing, a total of 16 image capturing operations are performed, such that the entire area illustrated in FIG. 7 becomes the image capturing completion area. Accordingly, even when the light receiving surface is smaller than the observation area and a blank area that cannot be imaged occurs only with the rotation of the imaging unit, the image data can be acquired with no gap through the combination with the parallel shifting of the subject, similar to the second exemplary embodiment. Note that, the subject may be rotated instead of the imaging unit, as in the first exemplary embodiment, and the rotation angles and the rotation directions of the imaging unit and the subject are not limited to those in the present exemplary embodiment.

As in the present exemplary embodiment, when the rotation of the imaging unit and the parallel shifting of the subject are performed, for example, the mechanism as illustrated in FIG. 11 may be used. Here, a support structure 1102 that supports a subject 1104 is moved in X and Y axis directions after an image capturing operation, to thereby shift an image capturing completion area 1101 and the light receiving surface of the imaging unit and capture an image of another observation area. In this case, as the support structure 1102 is brought into contact with an outer frame 1103, positioning can be performed in four positions and an image of the entire observation area can be captured as illustrated in FIG. 7. Note that, while the mechanism of FIG. 11 has a configuration capable of rotating the subject, a rotating base 1105 may be fixed not to be rotated when the image acquisition method according to the present exemplary embodiment is used. Here, in order to increase reproducibility of the position, a benching pin (not illustrated) may be provided on the outer frame 1103. Further, a mechanism capable of performing positioning in any of a plurality of positions using adsorption by vacuum chuck or magnetic force, or a mechanical mechanism (not illustrated) such as a mechanical clamp may be used.

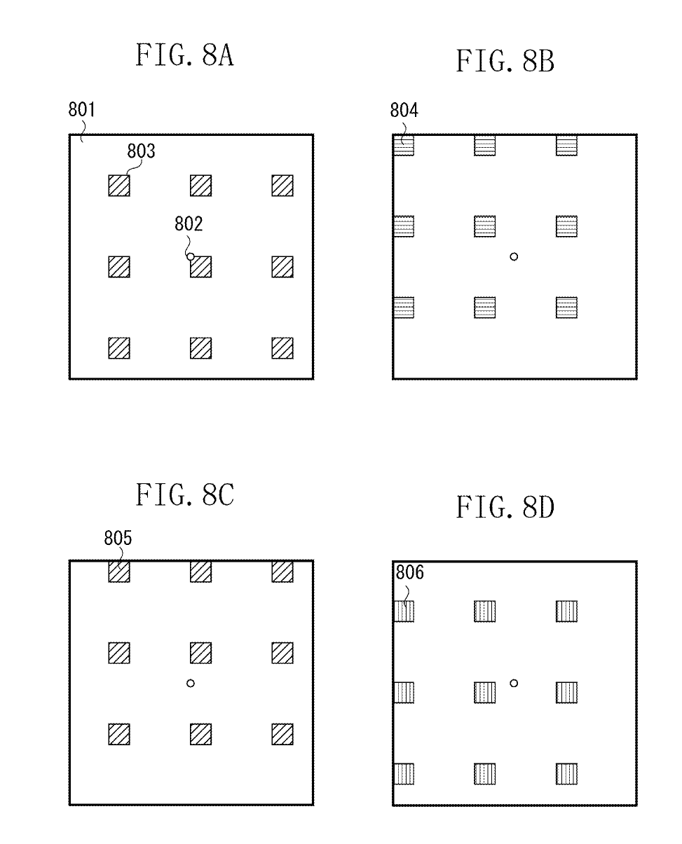

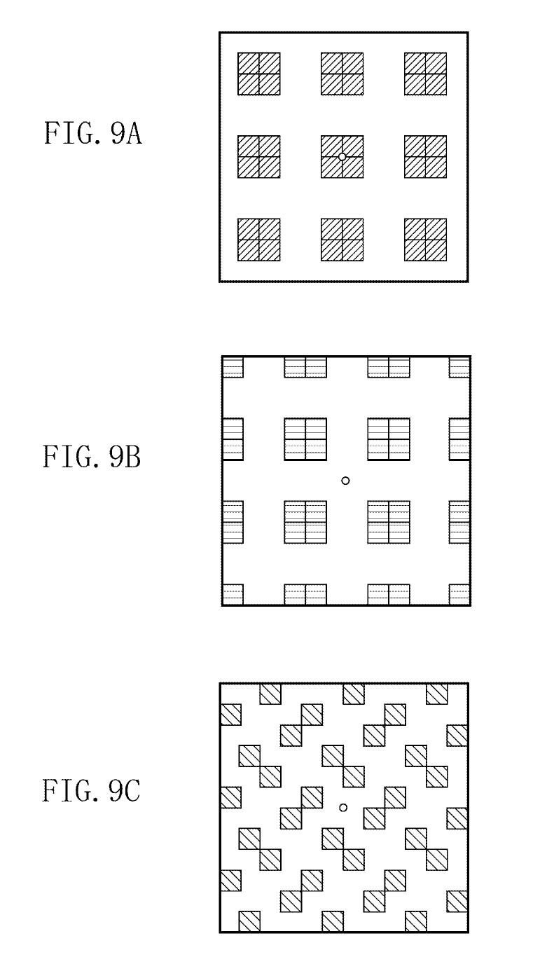

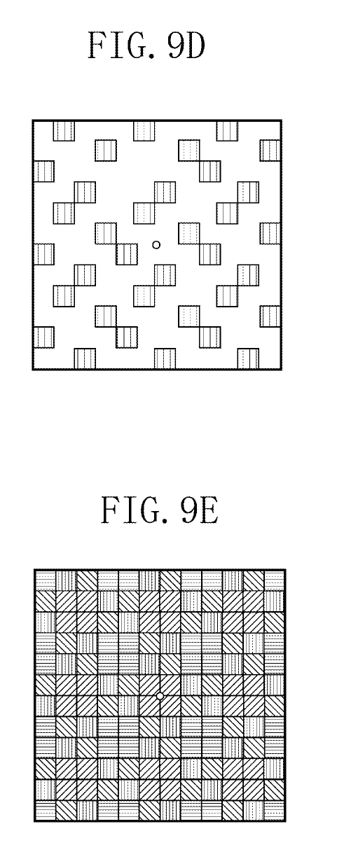

FIGS. 8A, 8B, 8C and 8D are diagrams illustrating a case in which a rotation center when the light receiving surfaces are rotated is changed to thereby capture an image of the observation area with no gaps. In the imaging unit of a fourth exemplary embodiment of the present invention, the light receiving surfaces are also arranged as illustrated in FIG. 5. 801 indicates an observation area, and 802 indicates a rotation center at the time of rotation of the imaging unit. FIGS. 8A to 8D illustrate light receiving surface positions 803 to 806 relative to the observation area 801. In FIGS. 8A to 8D, the light receiving surfaces are rotated around the rotation center 802 by 90° and image capturing is performed a total of four times in each of the light receiving surface positions 803 to 806. Accordingly, an image capturing completion area can be obtained as illustrated in each of FIGS. 9A to 9D. Also, it can be seen that the entire observation area 801 becomes the image capturing completion area by combining the image capturing completion areas, as illustrated in FIG. 9E. Thus, as the light receiving surface positions are arranged as indicated by 803 to 806 with respect to the rotation center 802, the image data with no gaps can be acquired even when the light receiving surfaces are arranged as illustrated in FIG. 5. Note that, the subject may be rotated instead of the imaging unit as in the first exemplary embodiment, and the rotation angles and the rotation directions of the imaging unit and the subject are not limited to those in the present exemplary embodiment.

Here, an example of a mechanism capable of changing the rotation center at the time of the rotation of the light receiving surface may include the mechanism as illustrated in FIG. 12. Here, an imaging unit 1202 capable of being parallel shifted in X and Y axis directions is arranged on a rotating base 1203. Ina state illustrated in FIG. 12, a light receiving surface 1201 is rotated around a rotation center 1204. The imaging unit 1202 is moved to four positions, i.e., positions in which each of positions 1205 matches the rotation center 1204 after movement. Thus, as the imaging unit 1202 is parallel shifted to change the rotation center at the time of the rotation of the light receiving surface 1201, the image capturing operation as illustrated in FIGS. 8A to 8D may be performed. Note that, the positioning mechanism as illustrated in FIG. 10 maybe applied to the mechanism of FIG. 12. As described above, the image data can be acquired with no gaps by rotating the imaging unit while changing the rotation center.

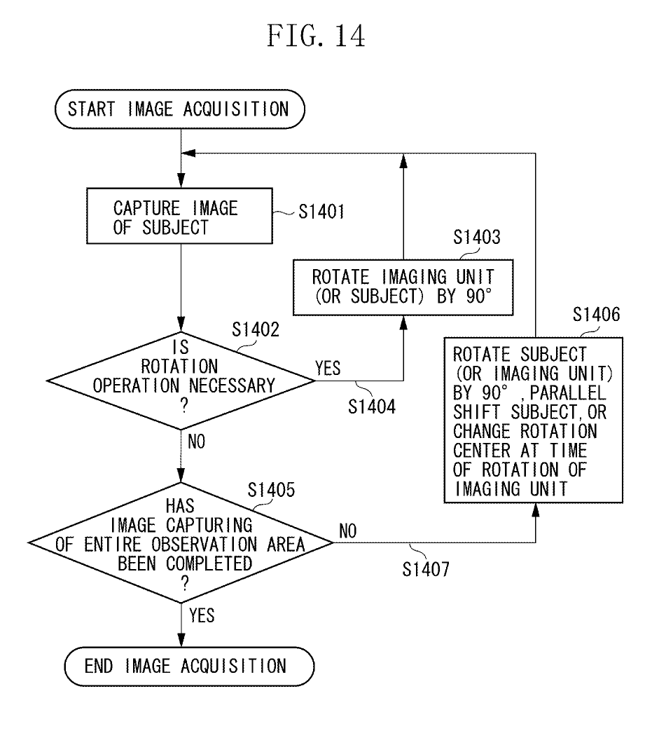

FIG. 14 illustrates a sequence when the image capturing of the subject is actually performed using the image acquisition method described in the above exemplary embodiment. First, the sequence starts in an initial state in which the subject and the imaging unit are not rotated. In step S1401, the image acquisition apparatus performs first image capturing. Also, in step S1402, the image acquisition apparatus performs a determination of whether a rotation operation of the subject or the imaging unit is necessary. If an image of an entire observation area can be captured through the first image capturing, for example, when an entire image of the subject is included in the light receiving surfaces in the initial state, the rotation operation is unnecessary (NO in step S1402).

However, when an image of a large area should be captured through the rotation operation (YES in step S1402), the process proceeds to step S1403, in which the image acquisition apparatus rotates the imaging unit (or the subject) by 90°, and the sequence returns to step S1401 to perform the image capturing (a first rotation and image capturing loop S1404). The first rotation and image capturing loop S1404 may be performed until the rotation operation is determined to be unnecessary in step S1402. Also, instep S1405, when the image capturing of the observation area is determined to have been completed (YES in S1405), the image acquisition apparatus ends the image acquisition operation.

However, if it is determined that an image of the entire observation area is not captured even after the image capturing of the first rotation and image capturing loop S1404 ends (NO in S1405), the sequence proceeds to next step S1406. In step S1406, the image acquisition apparatus captures an image of the rest of the observation area using an image acquisition method described in each exemplary embodiment. Specifically, the image acquisition apparatus performs any of operations of rotating the subject (or the imaging unit if the subject has been rotated in step S1403) by 90°, parallel shifting the subject, and changing the rotation center at the time of rotation of the imaging unit.

Thus, the image acquisition apparatus performs the image capturing until the rotation operation becomes unnecessary by moving the light receiving surface relative to the observation area and returning back to the first rotation and image capturing loop S1404, which is a second rotation and image capturing loop S1407. This second rotation and image capturing loop S1407 is repeatedly performed, and when the image capturing of the entire observation area in the subject is completed, the image acquisition flow ends. Thus, in the image acquisition apparatus according to the exemplary embodiment of the present invention, use of the sequence of the image acquisition method as described above enables an image of a desired area to be entirely captured.

The image acquisition apparatuses according to the exemplary embodiments of the present invention are not limited to a microscope in which an image-forming optical system is a magnification system to magnify and observe a subject, but are useful, for example, as an inspection apparatus for performing appearance inspection of a substrate (e.g., inspection of adhesion of foreign matter or of a flaw).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-214966 filed Sep. 29, 2011, which is hereby incorporated by reference herein in its entirety.

What is claimed is:

1. An image acquisition apparatus comprising:
an image-forming optical system configured to form an image of an observation area in a plane of a subject;
an image sensor including a light receiving surface configured to capture an image of the observation area formed by the image-forming optical system; and
a rotation unit configured to rotate at least one of the subject and the image sensor within a plane perpendicular to an optical axis of the image-forming optical system,
wherein, by driving of the rotation unit, the image acquisition apparatus changes a relative position of the observation area and the light receiving surface within the plane perpendicular to the optical axis of the image-forming optical system, to capture an image of an area in the observation area not captured at a time of image capturing before driving of the rotation unit.

2. The image acquisition apparatus according to claim 1, wherein the image sensor is arranged so that the light receiving surface is not rotationally symmetrical to a rotation center at a time of driving of the rotation unit.

3. The image acquisition apparatus according to claim 2, wherein the image sensor is arranged so that the light receiving surface includes the rotation center, and
wherein the subject is arranged so that an area optically conjugate to the light receiving surface within a plane including the subject includes the rotation center.

4. The image acquisition apparatus according to claim 1, wherein, when a rotation angle of the light receiving surface with respect to the observation area before driving of the rotation unit is set to 0°, the rotation unit is capable of being positioned in a position at which the rotation angle after driving of the rotation unit is one of 90°, 180°, and 270°.

5. The image acquisition apparatus according to claim 1, wherein the rotation unit is capable of parallel shifting at least one of the subject and the image sensor within the plane perpendicular to the optical axis of the image-forming optical system.

6. The image acquisition apparatus according to claim 1, further comprising an image processing unit configured to perform coordinate conversion of a plurality of image data acquired by the light receiving surface capturing an image of the observation area a plurality of times so that rotation angles of the plurality of image data are equal to one another.

7. The image acquisition apparatus according to claim 6, wherein the image processing unit is capable of combining the plurality of image data subjected to the coordinate conversion and generating image data of the entire observation area.

8. The image acquisition apparatus according to claim 1, wherein the image sensor includes a plurality of image sensors.

9. The image acquisition apparatus according to claim 1, wherein the rotation unit is capable of rotating both the subject and the image sensor within the plane perpendicular to the optical axis of the image-forming optical system.

10. An image acquisition apparatus comprising:
an image-forming optical system configured to form an image of an observation area in a plane of a subject;
an image sensor including a light receiving surface configured to capture an image of the observation area formed by the image-forming optical system; and
a rotation unit configured to rotate at least one of the subject and the image sensor within a plane perpendicular to an optical axis of the image-forming optical system,
wherein, by driving of the rotation unit, the image acquisition apparatus changes a relative position of the observation area and the light receiving surface within the plane perpendicular to the optical axis of the image-forming optical system,
wherein the image sensor is arranged so that the light receiving surface is not rotationally symmetrical to a rotation center at a time of driving of the rotation unit.

11. An image acquisition method comprising:
an image capturing step of capturing an image of an observation area within a plane of a subject formed by an image-forming optical system, using a light receiving surface of an image sensor; and
a first rotation step of rotating at least one of the subject and the image sensor within a plane perpendicular to an optical axis of the image-forming optical system,
wherein an image of an area in the observation area not captured in the image capturing step before the first rotation step is performed, is captured by performing the image capturing step each time after the first rotation step is performed.

12. The image acquisition method according to claim 11, wherein the first rotation step is a step of changing a rotation angle of the light receiving surface with respect to the observation area every 90°.

13. The image acquisition method according to claim 11, further comprising a parallel shifting step of parallel shifting at least one of the subject and the image sensor within the plane perpendicular to the optical axis of the image-forming optical system,
wherein an image of an area in the observation area not captured in the image capturing step before the parallel shifting step is performed, is captured by performing the image capturing step each after time the parallel shifting step is performed.

14. The image acquisition method according to claim 11, further comprising a second rotation step of rotating at least one of the subject and the image sensor around a rotation center different from a rotation center in the first rotation step within the plane perpendicular to the optical axis of the image-forming optical system,
wherein an image of an area in the observation area not captured in the image capturing step before the second rotation step is performed, is captured by performing the image capturing step each time after the second rotation step is performed.

15. The image acquisition method according to claim 14, wherein the second rotation step is a step of changing a rotation angle of the light receiving surface with respect to the observation area every 90°.

16. A microscope comprising:
an image-forming optical system configured to form an image of an observation area in a plane of a subject;
an image sensor including a light receiving surface configured to capture an image of the observation area formed by the image-forming optical system; and
a rotation unit configured to rotate at least one of the subject and the image sensor within a plane perpendicular to an optical axis of the image-forming optical system,
wherein, by driving of the rotation unit, the microscope changes a relative position of the observation area and the light receiving surface within the plane perpendicular to the optical axis of the image-forming optical system, to capture and image of an area in the observation area not captured at a time of image capturing before driving of the rotation unit.

17. The microscope according to claim 16, wherein the image-forming optical system is a magnification system.

18. The microscope according to claim 16, wherein
the rotation unit rotates both the subject and the image sensor;
an axis of rotation of the subject and an axis of rotation of the image sensor are parallel to each other;
the axis of rotation of the subject and the axis of rotation of the image sensor are not coincident with each other.
